(19) United States
(12) Patent Application Publication
(10) Pub. No.: US 2024/0278153 A1
(43) Pub. Date: Aug. 22, 2024

(54) Filtering device for plastic materials with cleaning system

(71) Applicants: Alessandro Sartori, Vicenza (IT); Break Machinery Srl, Grantorto (PD) (IT)

(72) Inventor: Alessandro Sartori, Arcugnano (VI) (IT)

(21) Appl. No.: 18/681,185

(22) PCT Filed: Aug. 2, 2022
(86) PCT No.: PCT/IB2022/057152

§ 371 Date: Feb. 5, 2024

(30) Foreign Application Priority Data
Aug. 6, 2021 (IT) 102021000021380

(51) Int. Cl. B01D 29/94; B01D 29/075; B01D 29/54; B01D 29/64; B29B 17/02

(52) U.S. Cl. CPC B01D 29/94; B01D 29/075; B01D 29/54; B01D 29/6476; B29B 17/02; B29B 2017/0224

(57) ABSTRACT

A filtering device for a plastic material in the molten state includes a hollow body having a mouth and a cover; an inlet way and an outlet way for the filtered plastic material; two filters arranged side by side; a rotary cleaning device arranged between the two filters and provided with scraping elements cooperating with the filtering surfaces; and an evacuation device configured to discharge the impurities toward an evacuation outlet, the evacuation device being arranged centrally in such a way that the impurities travel along equal paths with the same flow rate and discharge the impurities in a balanced manner on the evacuation device.

The present patent concerns systems for filtering plastic materials in the molten state, more specifically systems for filtering plastic materials in the molten state during plastic recycling processes.

More specifically, the present patent concerns the cleaning system of filtering devices for plastic materials in the molten state, in particular the systems for filtering plastic materials in the molten state during plastic recycling processes.

The problem of the recovery/recycling of plastic materials for reuse in the manufacture of new products is known and particularly felt.

The plastic material to be recycled is subjected to a melting process and at the same time filtered to eliminate any impurities. Typically, the molten and filtered material is then properly processed to make, for example, a granular product suited to be reintroduced in the known plastic production processes.

A device of the known type that carries out the filtration of raw plastic material in the molten state is provided with a cylindrical filtration chamber equipped with one or more filtering elements interposed between a feeding inlet for the raw plastic material to be filtered and an outlet, downstream of the filtering elements, for the discharge of the filtered molten plastic material.

Filtration chambers of the known type comprise a first part with closed bottom, preferably a cylindrical first part with closed bottom, and a cover which is associated with the mouth of the first part. When the cover is associated with/fixed to the mouth of the first part, the filtration chamber is closed, and the filtering device is ready for use. The cover is preferably fixed to the first part by means of screws and nuts that can be conveniently unscrewed for normal maintenance operations and/or repairs.

According to the known technique, the raw plastic material in the molten state is introduced in the filtration chamber and conveyed, under pressure, through filtering elements typically constituted by substantially planar (or cylindrical) filters provided with filtering through openings properly sized and suited to ensure the desired filtering capacity.

During operation with continuous feeding of raw material, impurities tend to gradually accumulate on the surface of the filter. Therefore, a cleaning system located inside the filtration chamber is provided to ensure continuous cleaning of the surface of the filter.

According to the known technique, the cleaning system comprises at least one fixed or movable (preferably rotary) scraper provided with scraping elements that slide across the surface of the filter to remove the impurities that have accumulated thereon. At the same time, the removed impurities are conveyed out of the filtration chamber. The impurities collected by the scraping elements are preferably conveyed towards the centre of the filter along a curved path and from there, through a channel, conveyed outside by a worm screw/screw feeder or an on/off valve that extends from the centre of the filter and exits from the filtration chamber.

According to a first known technique, the scraper and the screw feeder are set rotating together around a common rotation shaft conveniently driven by motorized means, usually an electric motor.

A drawback associated with the filtering devices of this type lies in that it is impossible to optimize and minimize the waste material as the rotation speed of the screw feeder and that of the scraper cannot be managed separately. According to a second known technique, on the contrary, the scraper is fixed and the filtering elements are set rotating. In addition, an independent screw feeder is associated with each filtering element.

The drawbacks associated with this second known technique are the presence of only one scraper per filtering surface and the need for a screw feeder for each filtering surface.

In order to overcome the aforementioned drawbacks, a new type of filtering device for a plastic material in the molten state has been designed and constructed.

Therefore, it is an object of the invention to provide a filtering device for a plastic material that makes it possible to improve the degree of cleanliness of the filtering elements compared to the devices of the known type.

It is another object of the invention to provide a filtering device for a plastic material that makes it possible to minimize the waste of material by using a single, independent screw feeder.

The objects specified above are achieved by means of a filtering device for a plastic material according to the attached claim 1, to which reference is made for the sake of brevity.

In particular, according to a first aspect of the present invention, the same concerns a filtering device for a plastic material in the molten state, said filtering device comprising:
a hollow body provided with a mouth and a cover suited to be associated with said mouth to define a filtration chamber;
at least one inlet way for the introduction of said plastic material in the molten state in said filtration chamber and at least one outlet way for the outlet of said filtered plastic material in the molten state from said filtration chamber;
a first filter and a second filter arranged side by side inside said filtration chamber in a position between said at least one inlet way and said at least one outlet way, said first filter being suited to define a first surface suited to filter said plastic material and collect any impurities and said second filter being suited to define a second surface suited to filter said plastic material and collect any impurities;
a cleaning device arranged between said first filter and said second filter;
an evacuation device suited to discharge said impurities collected by said cleaning device towards an evacuation outlet, said evacuation device being arranged centrally with respect to said cleaning device;
wherein said cleaning device comprises a rotary main body with a first side facing towards said first filter and provided with first scraping elements cooperating with said first filtering surface of said first filter and a second side facing towards said second filter and provided with second scraping elements cooperating with said second filtering surface of said second filter, said main body comprising a first plurality of axially symmetrical channels communicating with said first side and a second plurality of axially symmetrical channels communicating with said second side and suited to receive the impurities collected by said first scraping elements and said second scraping elements, respectively, and to convey them towards said evacuation device, said first plurality of axially symmetrical channels and said second plurality of axially symmetrical channels being defined in said main body staggered with respect to one another and arranged symmetrically with respect to the middle plane of said main body in such a way that said impurities pass through said first plurality of channels and said second plurality of channels along equal paths with the same flow rate and discharge said impurities in a balanced manner on said evacuation device through discharge openings arranged on said middle plane, guaranteeing the introduction of impurities in said evacuation device in completely equivalent positions.

Further specific operating characteristics of the device that is the subject of the present invention are illustrated in the corresponding dependent claims.

The characteristics of the new device are illustrated in greater detail in the following description with reference to the drawings, which are attached hereto by way of non-limiting example.

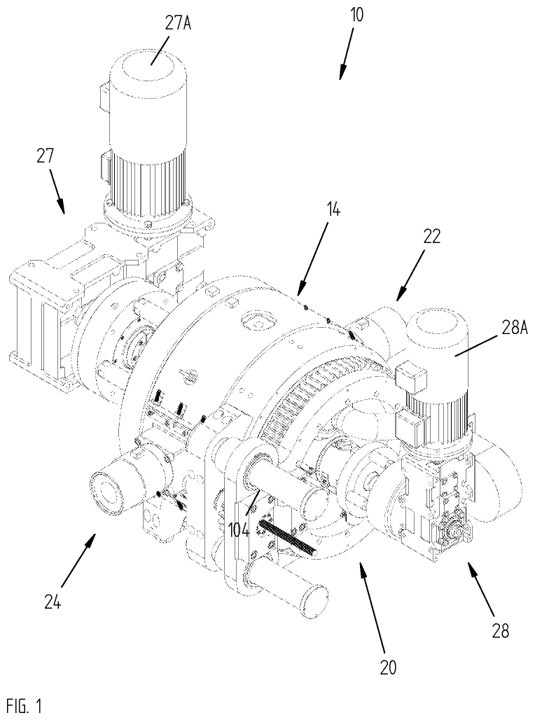

FIG. 1 shows an axonometric view of a filtering device according to a preferred embodiment of the invention.

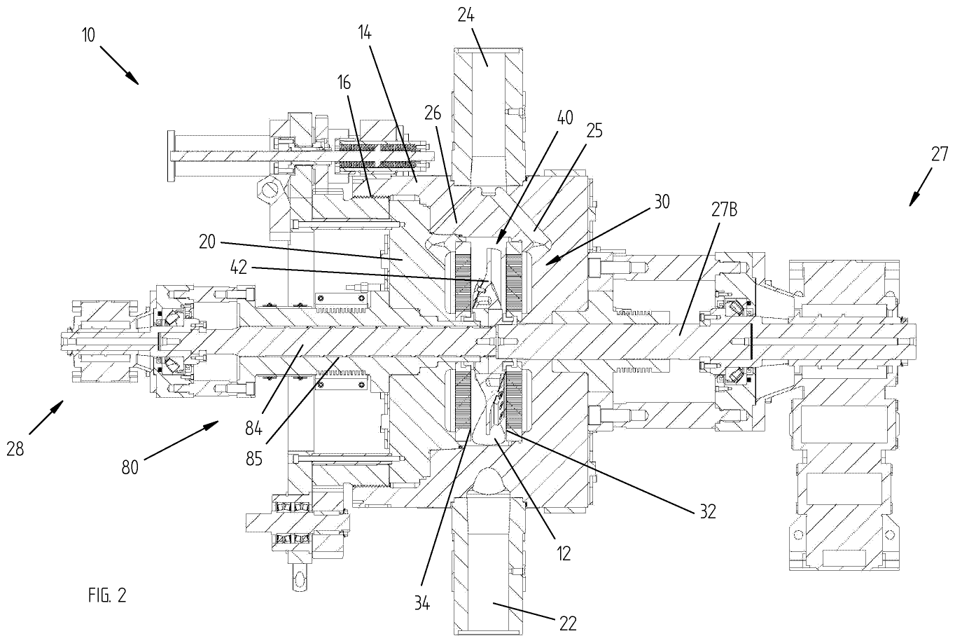

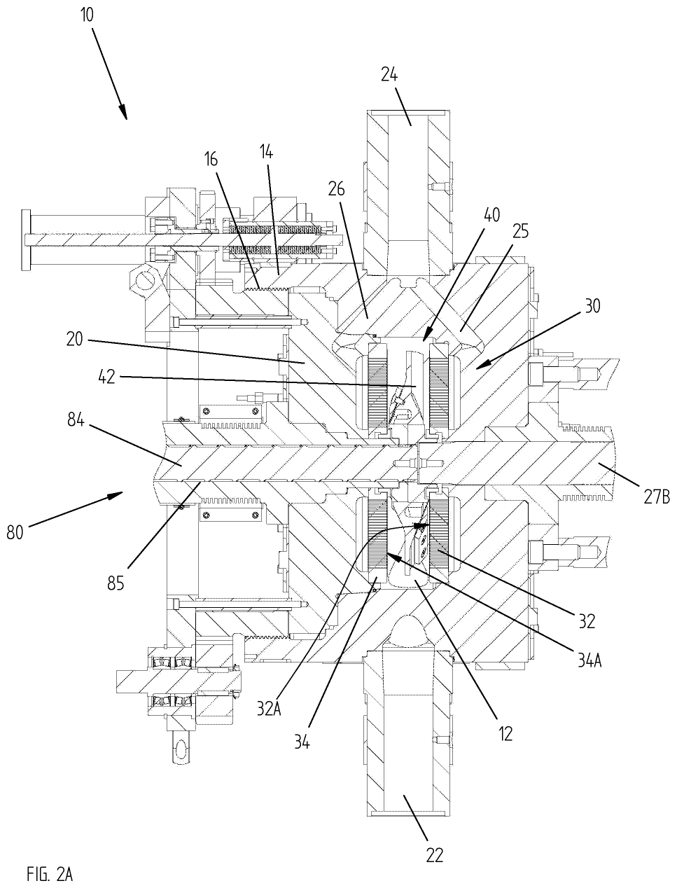

FIG. 2 shows a sectional view of the filtering device shown in FIG. 1 along a horizontal section plane.

FIG. 2A shows an enlarged detail of FIG. 2.

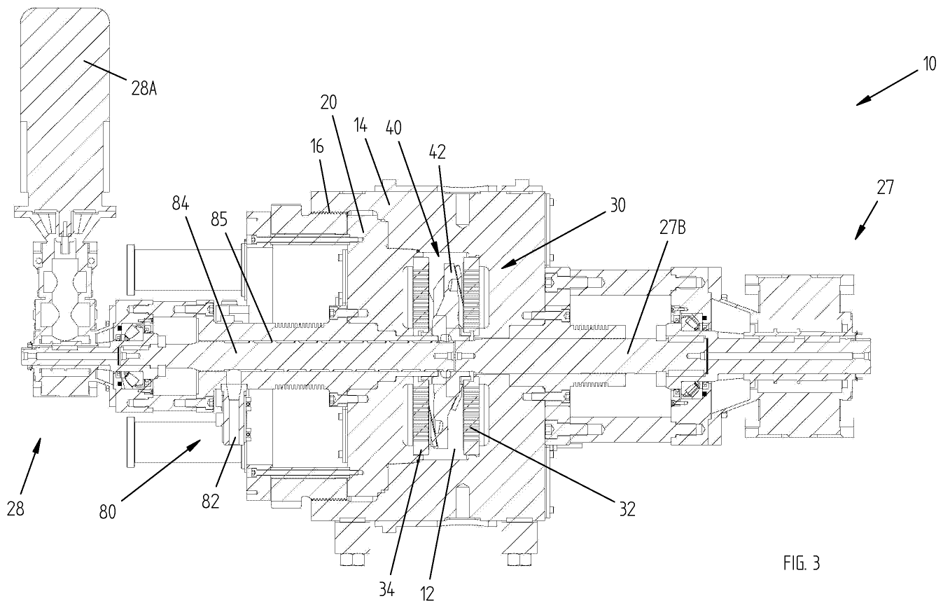

FIG. 3 shows a sectional view of the filtering device shown in FIG. 1 along a vertical section plane.

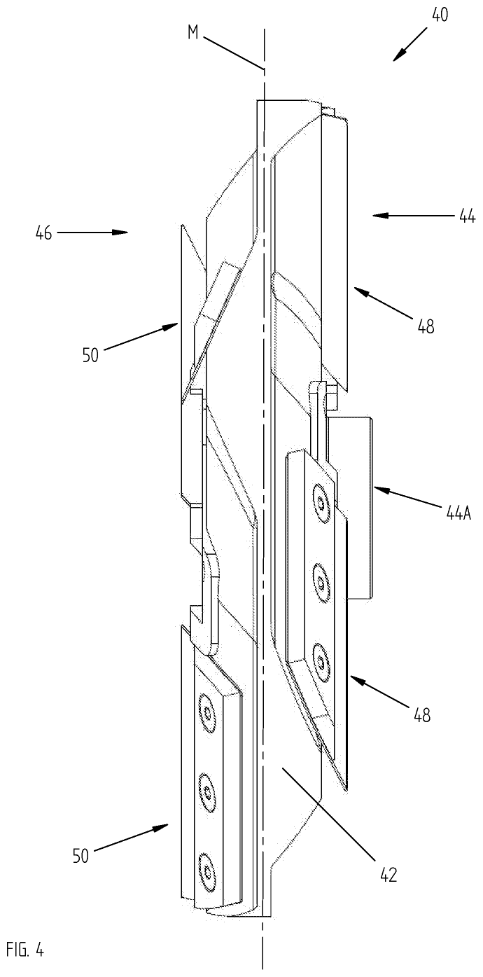

FIG. 4 shows an enlarged detail of an element of FIG. 2A isolated from the rest.

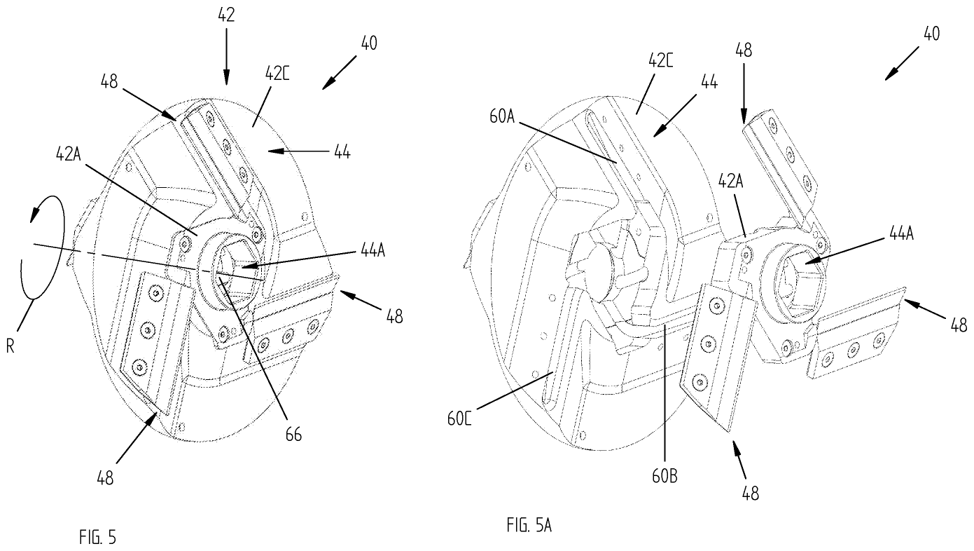

FIG. 5 shows an axonometric view from a first side of the element shown in FIG. 4.

FIG. 5A shows an exploded view of FIG. 5.

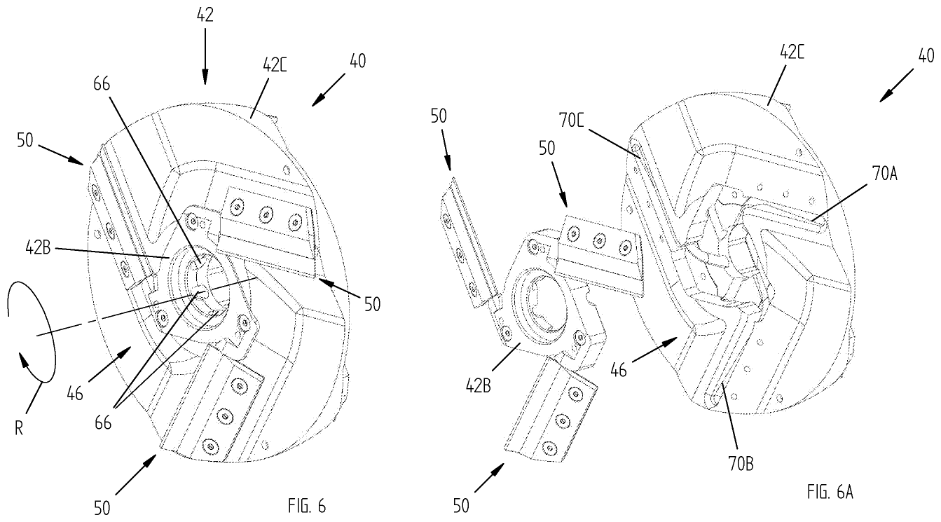

FIG. 6 shows a second axonometric view from a second side of the element shown in FIG. 4.

FIG. 6A shows an exploded view of FIG. 6.

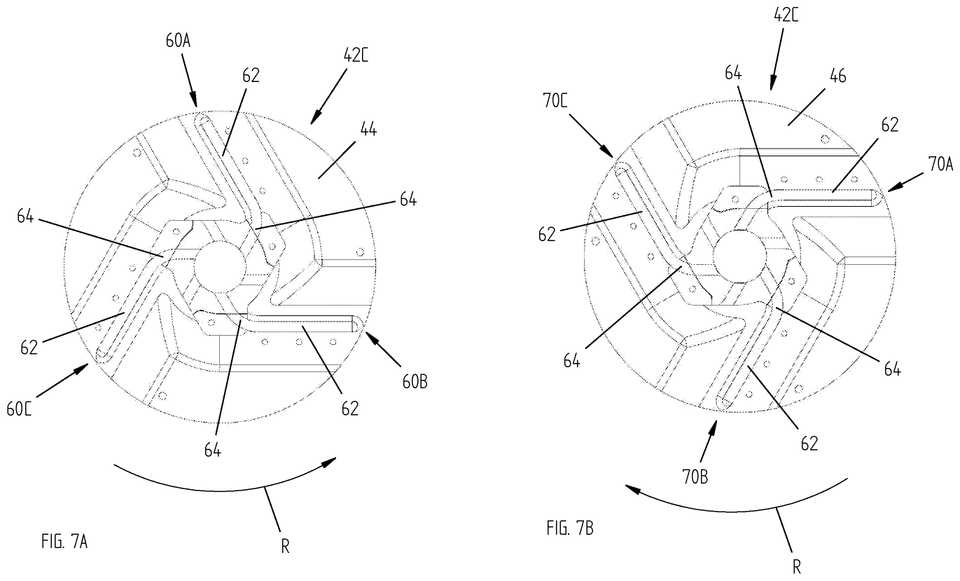

FIG. 7A shows a plan view of an element of FIG. 5A.

FIG. 7B shows a plan view of an element of FIG. 6A.

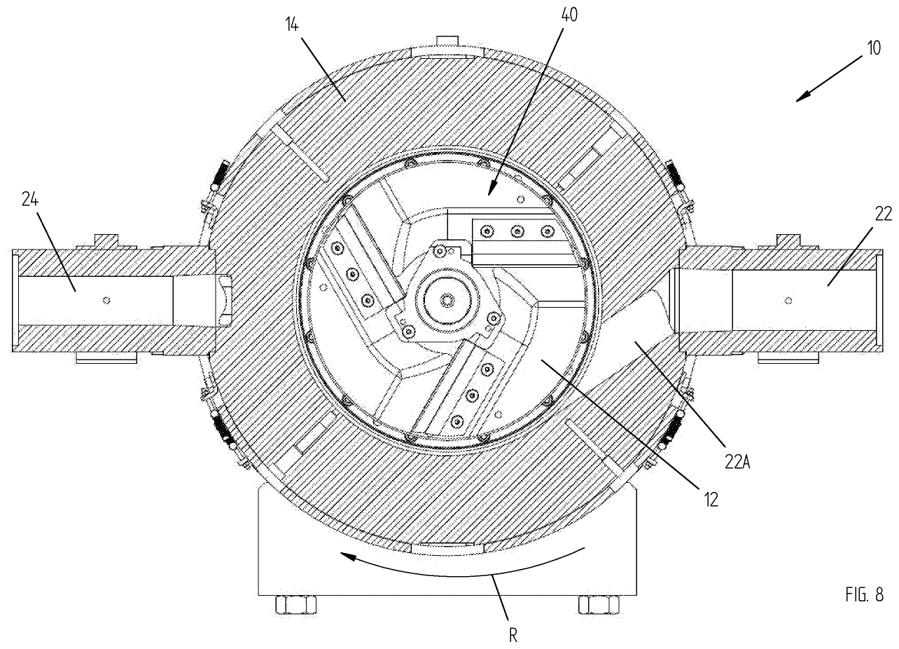

FIG. 8 shows a sectional view of the filtering device shown in FIG. 1 along a vertical section plane passing through the inlet way for the introduction of the material.

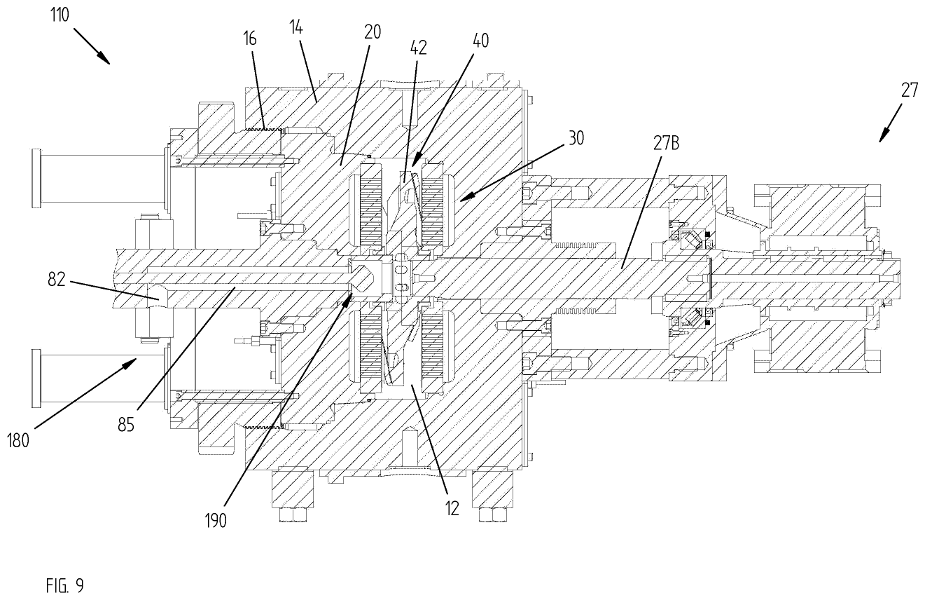

FIG. 9 shows a sectional view of a filtering device according to a variant embodiment of the invention.

A filtering device according to a preferred embodiment of the invention is indicated by the numeral 10 in FIGS. from 1 to 4.

The filtering device 10 according to the invention can be preferably used in a plastic recycling process.

The filtering device 10 has the function of filtering/stopping the impurities present in the raw plastic material to be recycled in such a way as to obtain a degree of purity that depends on the size of the meshes of the filtering element used.

To carry out this filtration operation, the raw plastic material to be recycled is first heated and brought to the molten state so that it can then be conveyed into the filtering device 10, more specifically into a filtration chamber 12 of the device 10 itself.

The filtering device 10 preferably has a hollow body 14 provided with a mouth 16 and a cover 20 suited to be associated with the mouth 16 to define the filtration chamber 12 (FIGS. 2, 3).

The hollow body 14 according to the preferred embodiment illustrated herein has a preferably cylindrical shape and the cover 20 consequently has a preferably circular cross-section.

An inlet way 22 is associated with the hollow body 14 so as to allow the introduction of the plastic material to be filtered in the molten state into the filtration chamber 12. An outlet way 24 is also associated with the hollow body 14 so as to allow the discharge of the filtered plastic material in the molten state from the filtration chamber 12.

Preferably, the inlet way 22 is associated with conveyor means, not shown and of a known type per se, suited to convey, under pressure, the material in the molten state to be filtered towards said inlet way 22.

Filtering means 30 are preferably arranged within the filtration chamber 12 in a position between the inlet way 22 and the outlet way 24.

According to an aspect of the present invention, the filtering means 30 comprise a first filter 32 and a second filter 34 arranged side by side in the filtration chamber 12 in a position between the inlet way 22 and the outlet way 24.

The first filter 32 and the second filter 34 preferably comprise two plane filtering discs arranged parallel to each other. In variant embodiments, the shape can be different and follow the internal shape of the filtration chamber. The first filter 32 defines a corresponding first filtering surface 32A suited to collect impurities during the filtration process and the second filter 34 defines a corresponding second filtering surface 34A suited to collect impurities during the filtration process (shown in FIG. 2A). Two respective collection channels 25, 26 for the filtered material, which preferably join at the level of the final outlet way 24, are defined downstream of the two filters 32, 34.

The channels 25 and 26 follow equal and symmetrical paths to help obtain flows having the same flow rate and pressure.

A cleaning device 40, described in greater detail below, is preferably arranged between the first and the second filter 32, 34, wherein said cleaning device 40 has the function of cleaning the first filtering surface 32A of the first filter 32 and the second filtering surface 34A of the second filter 34.

Preferably, an evacuation device 80 is also provided, which is suited to convey the impurities collected by said cleaning device 40 towards an evacuation outlet 82, visible in FIG. 3. The evacuation device 80 is preferably arranged centrally with respect to the cleaning device 40.

The evacuation device 80 preferably comprises an evacuation channel 85 which accommodates a rotary discharge element 84, preferably a worm screw or screw feeder, suited to receive the impurities collected in the filtration chamber 12 and move them along a longitudinal direction towards the evacuation outlet 82.

In a variant embodiment, shown in FIG. 9 and described in greater detail below, the evacuation device 180 preferably comprises an evacuation channel 85 and an on/off valve 190 suited to open to allow the impurities collected in the filtration chamber 12 to move, under pressure, towards the evacuation outlet 82.

Suitable rotation means 28, preferably an electric motor 28A with controlled speed, allow the controlled rotation of the rotary discharge element 84 during the operation of the filtering device 10.

According to an aspect of the present invention, the cleaning device 40 comprises a rotary main body 42, preferably circular in shape, having a first side 44 facing towards the first filter 32 and a second side 46 facing towards the second filter 34. The first side 44 is provided with first scraping elements 48 cooperating with the first filtering surface 32A of the first filter 32 and the second side 46 is provided with second scraping elements 50 cooperating with the second filtering surface 34A of the second filter 34.

The rotary main body 42 can therefore be rotated around its own rotation axis while it is not axially constrained.

The first scraping elements 48 and/or the second scraping elements 50 preferably comprise scraping blades rigidly connected to the respective sides 44, 46 of the main body 42, more preferably flexible scraping blades suited to be placed in contact with the respective first filtering surface 32A of the first filter 32 and second filtering surface 34A of the second filter 34. The flexibility of the scraping blades 48, 50 allows them to be compressed by the two filters 32, 34 at the moment when the device 10 is closed by the cover 20 and the parts of the scraping blades 48, 50 in contact with the filtering surfaces 32A, 34A provide the pressure required to scrape and remove impurities from the surfaces 32A, 34A themselves. This is facilitated by the fact that the main body 42 is not axially constrained and therefore is centred due to the pressure provided by the scraping blades 48, 50. The scraping blades 48, 50 are preferably arranged symmetrically on the two sides 44, 46 of the main body 42 with respect to the middle plane M of the main body 42 itself. Advantageously, the scraping blades 48, 50 deform substantially in the same manner on both sides 44, 46 of the main body 42 and thus exert the same pressure on the surfaces 32A, 34A of the filters 32, 34, ensuring better filtration quality (same degree of cleanliness of the filters 32, 34) and regular and equivalent wear of the filters 32, 34 and/or of the scraping blades 48, 50. The scraping blades 48, 50 are fixed to the respective sides 44, 46 of the main body 42 by means of fixing screws.

According to the preferred embodiment illustrated, three scraping blades 48, 50 are provided for each side 44, 46. In variant embodiments, however, the number of said blades can be different.

Suitable rotation means 27 allow the controlled rotation of the rotary main body 42 during the operation of the filtering device 10.

The rotation means 27 preferably comprise an electric motor 27A, more preferably with controlled speed, acting to rotate a drive shaft 27B. The end of the drive shaft 27B engages with a corresponding seat 44A made centrally in the first side 44 of the main body 42 of the cleaning device 40 (better visible in FIGS. 5 and 5A).

The end of the drive shaft 27B and the corresponding seat 44A in the main body 42 preferably have a polygonal shape, more preferably a hexagonal shape.

According to another aspect of the present invention, the main body 42 comprises a first plurality of channels 60A, 60B, 60C communicating with the first side 44 and a second plurality of channels 70A, 70B, 70C communicating with the second side 46.

The first plurality of channels 60A, 60B, 60C is conveniently created in the main body 42 to receive the impurities collected by the first scraping elements 48 and to convey them centrally towards the evacuation device 80, more preferably to convey them on the external surface of the rotary discharge element 84 or, in other cases, towards the evacuation device 180.

Analogously, the second plurality of channels 70A, 70B, 70C is conveniently created in the main body 42 to receive the impurities collected by the second scraping elements 50 and to convey them centrally towards the evacuation device 80, more preferably to convey them on the external surface of the rotary discharge element 84 or, in other cases, towards the evacuation device 180.

According to the preferred embodiment illustrated, there are therefore three axially symmetrical channels 60A, 60B, 60C associated with the corresponding three scraping blades 48 of the first side 44 (FIGS. 5A and 7A) and three axially symmetrical channels 70A, 70B, 70C associated with the corresponding three scraping blades 50 of the second side 46 (FIGS. 6A and 7B). In variant embodiments, however, the number of said channels can be different.

Preferably, the first plurality of channels 60A, 60B, 60C and the second plurality of channels 70A, 70B, 70C are defined in the main body 42 staggered with respect to one another and arranged symmetrically with respect to the middle plane M in such a way that the impurities pass through the first plurality of channels 60A, 60B, 60C and the second plurality of channels 70A, 70B, 70C along equal paths and discharge the impurities in an equivalent and balanced manner on the evacuation device 80.

Each channel 60A, 60B, 60C, 70A, 70B, 70C preferably comprises a first section 62 defined at the level of and below a respective scraping blade 48, 50 (see FIGS. 5A and 6A) and a second section 64 running through a corresponding discharge opening 66 and ending into an annular discharge chamber where the rotary discharge element 84 (screw feeder 84) is inserted. The first section 62 preferably comprises a straight section while the second section 64 is preferably curved so that it can reach the discharge opening 66. The channels 60A, 60B, 60C, 70A, 70B, 70C therefore preferably follow a non-radial pattern.

This pattern facilitates the flow of the impurities towards the discharge opening 66 considering the favourable direction of rotation of the cleaning device 40, indicated by R in the figures.

The discharge openings 66 of all the channels 60A, 60B, 60C, 70A, 70B, 70C, six openings 66 in the preferred embodiment illustrated, are arranged around the discharge chamber 68, equally spaced from each other, and they all lie in the middle plane M of the main body 42, guaranteeing the introduction of material with impurities in the evacuation device 80 in completely equivalent positions.

In this way, advantageously, it is possible to maintain equivalent and balanced flow rates through the channels 60A, 60B, 60C, 70A, 70B, 70C and to have corresponding equivalent and balanced pressures downstream of the two filters 32, 34.

Furthermore, preferably, the channels 60A, 60B, 60C, 70A, 70B, 70C have increasing cross section in the direction towards the evacuation device 80, so as to facilitate the outflow towards the discharge openings 66.

The embodiment according to the present invention therefore allows the cleaning device 40 to be constructed symmetrically, which makes it possible to maintain balanced and equivalent flow rates of the removed material coming from both filters 32, 34 by using only one evacuation device 80 or, in other cases, 180.

According to the illustrated embodiment, the rotary main body 42 comprises three modular parts 42A, 42B and 42C for ease of construction, disassembly and cleaning, which are shown in FIGS. 5A and 6A: two central parts 42A, 42B and an outer part 42C. The first rectilinear sections 62 of the first plurality of channels 60A, 60B, 60C (FIG. 7A) are preferably defined on the first side 44 of the outer part 42C and the first rectilinear sections 62 of the second plurality of channels 70A, 70B, 70C (FIG. 7B) are preferably defined on the second side 46 of the outer part 42C.

The solution therefore makes it possible to improve the degree of cleanliness of the filters 32, 34 and the filtration quality, using an evacuation system with a screw feeder 84 or an on/off valve 190.

According to the illustrated embodiment, furthermore, the rotary main body 42 and the rotary discharge element 84 are set rotating independently by means of the respective rotation means 27, 28. Advantageously, the respective rotation directions and the respective rotation speeds can be adjusted independently of each other and in such a way as to ensure that impurities are eliminated as efficiently as possible.

Preferably, when in operation, the rotary main body 42 and the rotary discharge element 84 rotate in the same direction. Furthermore, preferably, the rotation speed of the rotary discharge element 84 is higher than the rotation speed of the rotary main body 42 by such a value as to generate a tangential component of the speed of the material flowing out of the channels 66 concordant with the tangential speed of the rotary discharge element 84. In this way, the material exiting from the channels 66 comes into contact with the rotary discharge element 84 with good fluid dynamic efficiency.

Another advantageous aspect lies in that the inlet way 22 is configured with an inclined inlet portion 22A (FIG. 8) that is tangential to the inner diameter of the filtration chamber 12 so that the fluid rotates in a direction concordant with the rotation direction R of the cleaning device 40.

FIG. 9 shows a variant embodiment of the filtering device 110 according to the invention. Component parts corresponding or equivalent to those of the first embodiment are identified by the same reference numerals.

Said embodiment differs from the previously described embodiment, as mentioned above, in that the evacuation device 180 preferably comprises an evacuation channel 85 and an on/off valve 190 suited to open and allow the impurities collected in the filtration chamber 12 to be moved towards the evacuation outlet 82 under the action of pressure. The evacuation device 180, therefore, is not equipped with the rotary discharge element (metering screw).

The corresponding rotation means will therefore be omitted, too.

According to said embodiment, therefore, the impurities collected by the first and the second scraping elements 48, 50 are conveyed centrally towards the evacuation device 180 through the respective channels 60A, 60B, 60C, 70A, 70B, 70C and here, under the action of pressure, the on/off valve 190 opens to allow the impurities to move along the evacuation channel 85 and reach the evacuation outlet 82.

It is therefore evident from the description provided above that the device according to the invention allows the set objects to be achieved.

Therefore, with reference to the above description and the enclosed drawings, the following claims are made.

The invention claimed is:

1. A filtering device (10; 110) for a plastic material in a molten state, said filtering device (10; 110) comprising:
a hollow body (14) provided with a mouth (16) and a cover (20) configured to be associated with said mouth (16) to define a filtration chamber (12);
an inlet way (22) for an introduction of said plastic material in the molten state in said filtration chamber (12), and an outlet way (24) for an outlet of said filtered plastic material in the molten state from said filtration chamber (12);
a first filter (32) and a second filter (34) arranged side by side inside said filtration chamber (12) in a position between said inlet way (22) and said outlet way (24), said first filter (32) being configured to define a first surface (32A) adapted to filter said plastic material and collect any impurities therein and said second filter (34) being configured to define a second surface (34A) adapted to filter said plastic material and collect any impurities therein;
a cleaning device (40) arranged between said first filter (32) and said second filter (34); and
an evacuation device (80; 180) configured to discharge said impurities collected by said cleaning device (40) towards an evacuation outlet (82), said evacuation device (80; 180) being arranged centrally with respect to said cleaning device (40);
wherein said cleaning device (40) comprises a rotary main body (42) with a first side (44) facing towards said first filter (32) and provided with first scraping elements (48) cooperating with said first surface (32A) of said first filter (32) and a second side (46) facing towards said second filter (34) and provided with second scraping elements (50) cooperating with said second surface (34A) of said second filter (34), said rotary main body (42) comprising a first plurality of axially symmetrical channels (60A, 60B, 60C) communicating with said first side (44) and a second plurality of axially symmetrical channels (70A, 70B, 70C) communicating with said second side (46) and configured to receive the impurities collected by said first scraping elements (48) and said second scraping elements (50), respectively, and to convey the impurities towards said evacuation device (80; 180), said first plurality of axially symmetrical channels (60A, 60B, 60C) and said second plurality of axially symmetrical channels (70A, 70B, 70C) being defined in said main body (42) staggered with respect to one another and arranged symmetrically with respect to a middle plane (M) of said main body (42) in such a way that said impurities pass through said first plurality of channels (60A, 60B, 60C) and said second plurality of axially symmetrical channels (70A, 70B, 70C) along equal paths with a same flow rate and discharge said impurities in a balanced manner on said evacuation device (80; 180) through discharge openings (66) arranged on said middle plane (M), thereby providing for an introduction of the impurities in said evacuation device (80; 180) in completely equivalent positions.

2. The filtering device (10; 110) according to claim 1, further comprising first rotation means (27) for rotating said main body (42) of said cleaning device (40).

3. The filtering device (10) according to claim 1, wherein said evacuation device (80) comprises an evacuation channel (85) which houses a rotary discharge element (84), configured to receive and move said impurities collected in said filtration chamber (12) along a longitudinal direction towards said evacuation outlet (82).

4. The filtering device (10) according to claim 3, further comprising second rotation means (28) for rotating said rotary discharge element (84).

5. The filtering device (10) according to claim 3, wherein said main body (42) of said cleaning device (40) and said rotary discharge element (84) rotate in the same rotation direction, wherein a rotation speed of said rotary discharge element (84) is higher than a rotation speed of said main body (42) by such a value as to generate a tangential component of a speed of material flowing out of said discharge openings (66) that is consistent with a tangential speed of said rotary discharge element (84).

6. The filtering device (10; 110) according to claim 1, wherein one or more channels of said first plurality of channels (60A, 60B, 60C) and/or of said second plurality of channels (70A, 70B, 70C) have an increasing cross section towards said evacuation device (80; 180).

7. The filtering device (10; 110) according to claim 1, wherein said first scraping elements (48) and/or said second scraping elements (50) comprise scraping blades configured to be arranged in contact with said first surface (32A) of said first filter (32) and/or with said second surface (34A) of said second filter (34).

8. The filtering device (10; 110) according to claim 7, wherein said flexible scraping elements (48) maintain said rotary main body (42) in an operating position centered between said first filter (32) and said second filter (34), and wherein said rotary main body (42) is not constrained axially.

9. The filtering device (10; 110) according to claim 1, wherein said evacuation device (180) comprises an evacuation channel (85) and an on/off valve (190) configured to open to allow a movement of said impurities collected in said filtration chamber (12) towards said evacuation outlet (82) under action of pressure.

10. The filtering device (10; 110) according to the claim 1, wherein in the hollow body (14) closed by the cover (20) all the scraping elements (48, 50) are subjected to a same degree of compression.
